(19) United States
(12) Patent Application Publication
(10) Pub. No.: US 2014/0244330 A1
(43) Pub. Date: Aug. 28, 2014

(54) SYSTEM AND METHOD FOR ASSESSING AND MANAGING A FACILITY

(71) Applicant: INNOVATIONS 10.01, LLC, KANSAS CITY, MO (US)

(72) Inventor: Eric Hall, Lee's Summit, MO (US)

(73) Assignee: INNOVATIONS 10.01, LLC, KANSAS CITY, MO (US)

(21) Appl. No.: 14/186,578

(22) Filed: Feb. 21, 2014

Related U.S. Application Data
(60) Provisional application No. 61/768,267, filed on Feb. 22, 2013.

(51) Int. Cl. G06Q 10/06

(52) U.S. Cl. CPC G06Q 10/063114
USPC 705/7.15

(57) ABSTRACT

A web-based software as a service (SaaS) system and method that is designed to document and manage multiple participants involved in a construction project. The system and method can be used during or at the end of a construction project to document and manage a punch list. The present invention manages this process electronically and with higher functionality and interactivity than traditional punch list tools. In addition to punch list activities, the system can document multiple types of issues that arise during the course of a project, including issues arising during a project assessment, a project inspection, the closeout of the project, or similar types of events at a construction project. The invention uses an electronic “ticket” to document the imperfections, defects, damage, and incomplete items (collectively, the “deficiency” or “deficiencies”) discovered during a project assessment, a project inspection, or the closeout of a project.

### CROSS-REFERENCE TO RELATED APPLICATIONS

The present application claims priority to and incorporates herein by reference U.S. Provisional Patent Application Serial No. 61/768,267 filed on Feb. 22, 2013.

### BACKGROUND OF THE INVENTION

At the conclusion of nearly every construction project, a “punch list” is generated to document incomplete items, minor defects and damage, and final closeout activities that are necessary to bring a project to final completion. The life of a construction project has many phases. These phases include a pre-design phase, a design phase, a documentation phase, a pricing phase, an implementation phase, and, lastly, an operations phase. In the pre-design, design, and documentation phases, the parties to the project are concerned with moving from generic concepts about the project to detailed drawings and specifications from which the project can actually be built and from which pricing can be obtained. In the pricing phase, contractors and subcontractors can review the documentation and provide pricing, for which the parties can contract for the construction of a complete project. The implementation phase includes all project construction and administration processes. The operations phase begins when the contractor is complete and the owner takes possession of, and starts using, the project.

During the implementation phase, the project work may be installed with some level of imperfection and damage. Additionally, pieces of work may be installed that are not fully complete according the drawings and specifications. The punch list process is a two part process that is typically performed in order to remedy these problems and reach full completion of the project. The first part is a documentation process by which the contractor and subcontractors work with the project owner and its representatives to document these imperfections, defects, damage, and incomplete items. The second part is a performance process whereby the contractor performs the necessary work to rectify the imperfections, defects, damage, and incomplete items. This two part process can be repeated until all parties agree that the necessary level of final completion is reached.

After the facility is constructed, similar problems arise with assessing the conditions of the constructed facility, listing attributes that need correction or maintenance performed, assigning the task of correcting or performing maintenance to a specific responsible party, and managing the process of completing such tasks.

Historically, the process of both creating and completing a list has been done on paper. The owner and its representatives, including construction managers and/or designers, identified the imperfections, defects, damage, and incomplete items on the project, including, often, physically marking the location of the issue with some type of physical marking. Then, the owner or its representative or even the contractor prepared a paper punch list that listed all of the noted issues. That overall, comprehensive list of all items of needed work and rework may be created and recreated several times over, with varying degrees of specificity and information. Additionally, individual punch lists may be generated room by room or area by area or even according to the work trade or type of item affected. Hundreds of paper punch lists could be generated depending on the size of the project and the number of issues to resolve.

However, the process of using paper punch lists has numerous drawbacks. The punch lists themselves are often tacked or taped to the area in question, where the contractor and its subcontractors can review and begin work on the list of imperfections, defects, damage, and incomplete items. Sometimes, the paper punch list may simply get lost or even damaged during the process of performing the punch list work. Also, some work may be so massive or so complex that attaching a paper punch list is simply impracticable, resulting in the need for additional in-person communications or manual distribution of a punch list. Further, the use of paper punch lists are inherently difficult to track, as multiple paper versions are created, replaced, superseded, and so on. Paper punch lists are subject to misplacement, miscommunication, or misinterpretation, and they lack an ability to ask questions and resolve concerns and discrepancies in an efficient manner

More recently, the punch list process has been performed in electronic formats, like word processing documents, spreadsheets, or other similar types of unstructured data. These records include references to the separate drawings and specifications that address that particular item of work that is being identified as imperfect, defective, damaged, or incomplete. These punch lists are then shared and reviewed by way of electronic transmission, like fax and email. These punch lists also include the sharing of multiple revisions and/or versions. These punch lists may have a great deal of specificity or may be vague and ambiguous or may be a combination of both. This advancement in punch lists eliminated some, but not all, of the problems of paper punch lists.

Electronic management of punch list items and work flow is clearly desirable over manual management of punch lists. Absent a consistent records management procedure for the electronic punch list records, however, these records also can become subject to issues of miscommunication, misinterpretation, version control, and communication inconsistencies. Applying version control and consistency is desirable over the use of multiple copies of differing word processing or spreadsheet records; however the process is still subject to possible error and miscommunication. Additionally, the use of electronic records still requires reference to other document sources, like the drawings and specifications, and often requires meetings and phone calls to ensure clear communication.

Some software programs have been proposed in the art to progress beyond the current state of manual/paper punch list process or even the non-intuitive electronic punch list process.

A more comprehensive and effective system is needed to advance the punch list process beyond the current status of either the paper punch lists or electronic punch lists. A new system is needed that will address issues of effective and timely communication, simplified data accessibility, version control, work flow sequences, and the need for a user friendly interface.

### SUMMARY OF THE INVENTION

This invention relates generally to a method and system for managing a construction project and, more particularly, to systems and methods for managing the final items of work on uncompleted items, minor defects, and final closeout items to render a construction project complete and finished.

In one embodiment, the invention relates to a method for tracking a punch list. The method includes creating, via a processor, a ticket listing at least one deficiency based on inputs from a Requestor's remote device. Thereafter, at least a first Assignee is selected for the deficiency based on inputs from the Requestor's remote device. The ticket is then saved in an electronic memory, which allows the first Assignee to view the ticket via the first Assignee's remote device. Once the first Assignee has completed the work, the first Assignee may report completion of work on the deficiency via the Assignee's remote device. The ticket is then closed upon the Requestor's acceptance of all completed work on the deficiency.

In another embodiment, the invention relates to a method of administering a punch list. The method includes the step of allowing a user to enter an off-line mode via a remote device. The user makes at least one selection from the remote device regarding which tickets are to be downloaded prior to switching to off-line mode, which is accepted by servers. The user then makes another selection via the remote device regarding the desired data types of files associated with the tickets to be downloaded, which is also accepted by the servers. The selected tickets and the data files associated therewith are then provided to the remote device for off-line use. Once the remote device reestablishes a connection with the servers, the servers re-synchronize the tickets and data files for any edits made to such tickets.

In another embodiment, the invention relates to a system for managing a facility. The system includes a database for storing tickets associated with the facility in an electronic memory, as well as a processor for communicating with a Requestor's remote device via a network. The processor receives inputs from the Requestor's remote device regarding the creation of a new ticket listing at least one deficiency, in which the lists an Assignee. The electronic memory stores the new ticket therein, with associated criteria related to the deficiency. The processor also communicates with an Assignee's remote device to provide the ticket to the Assignee remote device, and receives a report of completion of work on the deficiency from the Assignee's remote device. The processor then updates the ticket in the electronic memory to reflect completion, and closes the ticket in the electronic memory upon the Requestor's acceptance of all completed work on the deficiency.

Other and further objects of the invention, together with the features of novelty appurtenant thereto, will appear in the course of the following description.

### BRIEF DESCRIPTION OF THE DRAWINGS

In the accompanying drawings, which form a part of the specification and are to be read in conjunction therewith:

FIG. 1 illustrates a block diagram of an example computer system as is known in the art.

FIG. 2 illustrates a block diagram of the interconnection between remote devices and a system via the Internet.

FIG. 3 illustrates a flow chart of a process for creating a ticket according to an embodiment of the present invention.

FIG. 4 illustrates a flow chart of a ticket action process according to an embodiment of the present invention.

FIG. 5 illustrates a flow chart of a process for viewing tickets according to an embodiment of the present invention.

FIG. 6 illustrates a flow chart of a process for syncing a remote device prior to off-line work according to an embodiment of the present invention.

### DETAILED DESCRIPTION OF THE INVENTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic dekriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the faur of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

Several definitions will now be addressed for the purposes of this document. A “Systems Administrator” is generally a global administrator, and is likely an employee of or affiliated with the owner of the system described herein. The Systems Administrator may have total project visibility, but may not have the ability to create or perform actions on tickets. A “Project Owner” is typically a general contractor's project manager. The Project Owner is likely to be the main contact for punch list management, with the ability to flex custom categories, create tickets, and perform both requestor and assignee actions on tickets. An “Admin Requestor” is typically a general contractor's superintendent or the project's architect. The Admin Requestor may create new tickets, flex custom categories, and perform requestor actions on other requestors' tickets. A “Requestor” is typically a representative of a general contractor or designer or owner. A Requestor may create new tickets and perform actions on their own tickets. An “Assignee” is likely a trade contractor, and are typically the parties responsible for completing work described in a ticket. Assignees may perform actions on tickets assigned to them, although they may be able to see many or all tickets. A “Delegate” is typically a 2^{nd} tier trade contractor, to whom work is delegated by an Assignee as appropriate. Delegates may not be able to see tickets other than those to which they have been assigned, but they may be able to perform actions on tickets assigned to them.

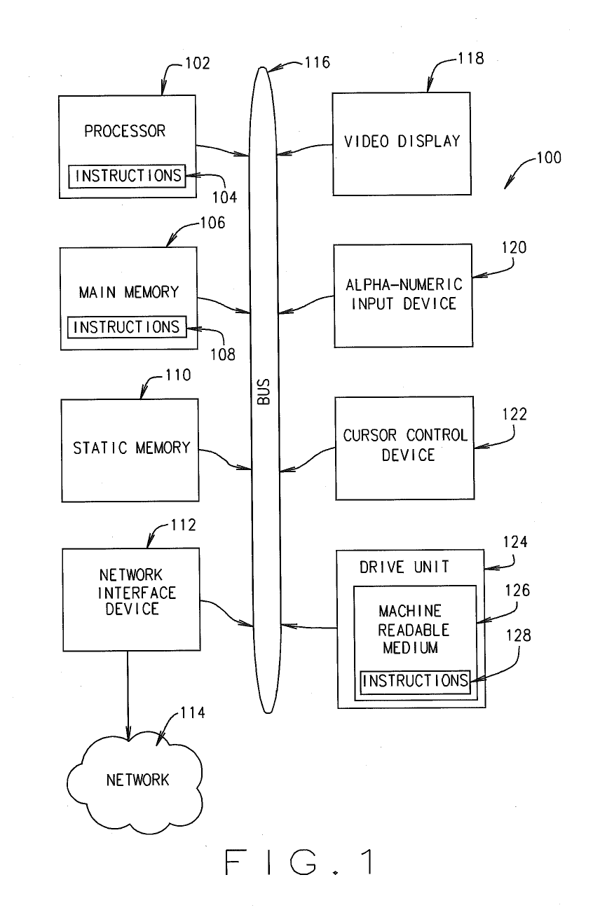

FIG. 1 is a block diagram of an example embodiment of a computer system 100 upon which an embodiment's inventive subject matter may execute. The description of FIG. 1 is intended to provide a brief, general description of suitable computer hardware and a suitable computing environment in conjunction with which the embodiments may be implemented. In some embodiments, the embodiments are described in the general context of computer-executable instructions, such as program modules, being executed by a computer. Generally, program modules include routines, programs, objects, components, data structures, etc., that perform particular tasks or implement particular abstract data types.

The system as disclosed herein can be spread across many physical hosts. Therefore, many systems and sub-systems of FIG. 1 can be involved in implementing the inventive subject matter disclosed herein.

Moreover, those skilled in the art will appreciate that the embodiments may be practiced with other computer system configurations, including hand-held devices, multiprocessor systems, microprocessor-based or programmable consumer electronics, network PCs, minicomputers, mainframe computers, and the like. The embodiments may also be practiced in distributed computer environments where tasks are performed by I/O remote processing devices that are linked through a communications network. In a distributed computing environment, program modules may be located in both local and remote memory storage devices.

In the embodiment shown in FIG. 1, a hardware and operating environment is provided that is applicable to both servers and/or remote clients.

With reference to FIG. 1, an example embodiment extends to a machine in the example form of a computer system 100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 100 may include a processor 102 (e.g., a central processing unit (CPU), a graphics processing unit (GPU), or both), a main electronic memory 106 and a static electronic memory 110, which communicate with each other via a bus 116. The computer system 100 may further include a video display unit 118 (e.g., a liquid crystal display (LCD) or a cathode ray tube (CRT)). In example embodiments, the computer system 100 also includes one or more of an alpha-numeric input devices 120 (e.g., a keyboard), a user interface (UI) navigation device or cursor control device 122 (e.g., a mouse, a touch screen), a disk drive unit 124, a signal generation device (e.g., a speaker), and a network interface device 112. The aforementioned components also communicate with each other via the bus 116.

The disk drive unit 124 includes a machine-readable medium 126 on which one or more sets of instructions 128 and data structures (e.g., software instructions) embodying or used by any one or more of the methodologies or functions described herein are stored. The instructions 128 may also reside, completely or at least partially, within the main memory 108 or within the processor 104 during execution thereof by the computer system 100, the main memory 106 and the processor 102 also constituting machine-readable media.

While the machine-readable medium 126 is shown in an example embodiment to be a single medium, the term “machine-readable medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that are able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 128 may further be transmitted or received over a communications network 114 using a transmission medium via the network interface device 112 and utilizing any one of a number of well-known transfer protocols (e.g., FTP, HTTP). Examples of communication networks include a local area network (LAN), a wide area network (WAN), the Internet, mobile telephone networks, plain old telephone service (POTS) networks, wireless data networks (e.g., Wi-Fi, WiMAX, and LTE networks), as well as any proprietary electronic communications systems that might be used. The term “transmission medium” shall be taken to include any intangible medium that is capable of storing, encoding, or carrying instructions for execution by the machine, and includes digital or analog communications signals, or other intangible medium to facilitate communication of such software.

The example computer system 100, in the preferred embodiment, includes operation of the entire system on a remote server with interactions occurring from individual connections over the network 114 to handle user input as an internet application

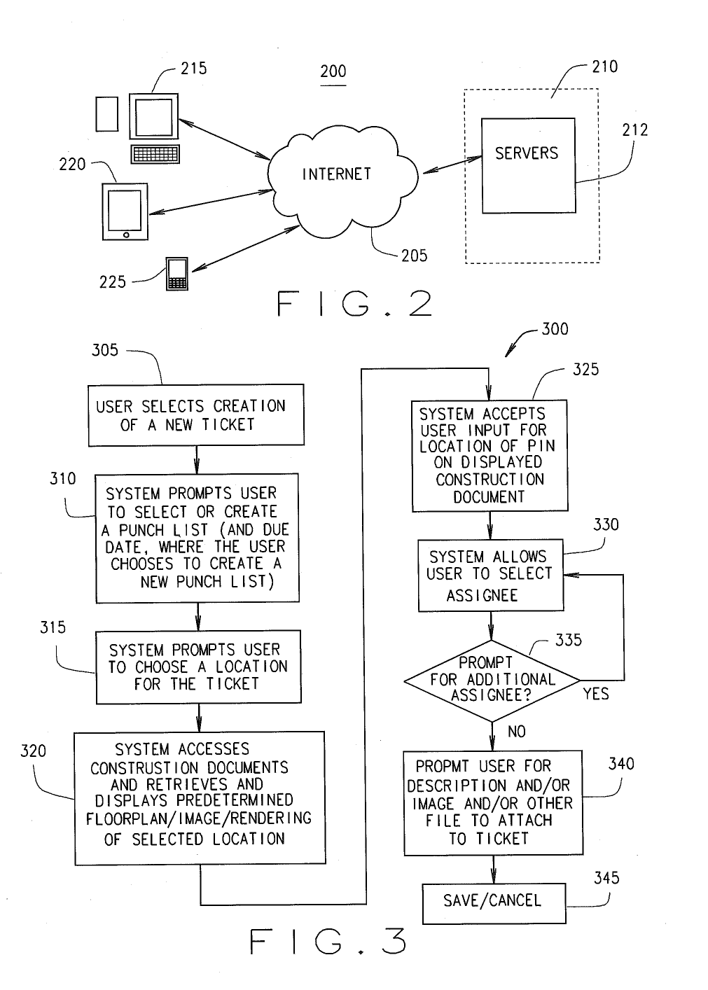

FIG. 2 illustrates a block diagram of an exemplary system 200. In system 200, punch list system 210 includes servers 212 which communicate with remote devices 215, 220, 225 via the Internet 205. Remote devices may be a desktop or laptop computer 215, a tablet 220, and/or a smartphone 225. Other computer systems are also envisioned, as would be understood by one of ordinary skill in the art. As will be understood, users access the punch list system 210 on servers 212 on their remote devices 215, 220, 225 via the Internet 205.

The present invention is a web-based software as a service (SaaS) system that is designed to document and manage multiple participants involved in a construction project. More particularly, the present invention can be used during or at the end of a construction project to document and manage a list of items that need to be completed, usually due to deficiencies in the construction project (generally referred to as a “punch list”). The present invention manages this process electronically and with higher functionality and interactivity than traditional punch list tools. In addition to punch list activities, the system can document multiple types of issues that arise during the course of a project, including issues arising during a project assessment, a project inspection, the closeout of the project, or similar types of events at a construction project. The invention uses an electronic “ticket” to document the imperfections, defects, damage, and incomplete items (collectively, the “deficiency” or “deficiencies”) discovered during a project assessment, a project inspection, or the closeout of a project.

As can be .seen in FIG. 3, a user, such as a Project Owner, Admin Requestor, or Requestor can create a new ticket via process 300 via a remote device 215, 220, 225. At step 305, a user who is authorized to create new tickets chooses to create a new ticket. At step 310, the system 210 prompts the user to select an existing punch list or create a punch list. Where the user chooses to create a new punch list, the system 210 also accepts a punch list title and a due date from the user. It is noted that the system 210 may auto-populate various fields, such as the punch list field, with the most recent ticket created by the user. The user would then be able to modify the pre-populated punch list at step 310, rather than receive a prompt to select a punch list. At step 315, the system 210 prompts the user to select a room/location for the ticket. The user may select a location from an existing list of locations, or may search for a specific location, or may use a QR code associated with the desired location.

Once the location/room is chosen at step 315, at step 320 the system 210 accesses construction documents relating to the selected location, such as floor plans, images, renderings, or other documents that provide some way of viewing the selected location. Essentially, the construction document is an underlying image that serves as a map. The system 210 then retrieves and displays such an underlying image relating to selected location. The construction document selected as the underlying image map may be predetermined by a default choice (e.g., a floor plan), but could also be set specifically for a given room or type of room. At step 325, the system 210 allows the user to place a digital pin on the displayed map to illustrate the location of the deficiency in the selected room, and stores this placement of the pin. Placing a digital pin is optional, but often helpful. The user may move the pin if necessary by touching the pin again. Further, the user may be able to zoom in or out on the map to more accurately place the pin. As the overall plan for the project may be very large, a key image showing an overview of the whole plan or a large portion of the plan containing the selected room may be shown to the user, for perspective. The pin may be placed in either or both of a plan-view document and an elevation-view document, for specificity.

At step 330, the system 210 allows the user to select an Assignee for the ticket. The user may select an Assignee from a list, or search for a specific Assignee, or even invite a new Assignee that is not yet on the project. At step 335, the user may select whether additional Assignees are needed. If the user would like to assign an additional Assignee, the system 210 reverts to step 330. The user may also select the order in which Assignees are needed. If the user has finished adding Assignees, the system 210 advances to step 340 in which the user is prompted for information relating to the deficiency. The user may select a category and/or subcategory relating to the deficiency from a pre-populated list, or create a new category/subcategory as needed. For non-limiting examples, categories may include “carpentry,” “electrical,” “landscaping,” etc. For the “carpentry” category, some non-limiting examples of subcategories may be “molding,” “door trim,” “baseboards,” etc. The user may select a specific action relating to the deficiency, including but not limited to “clean,” “damaged,” “missing,” etc. Of course, the user can also input any free form explanation of the deficiency, as desired. Further, the user can add a photograph or any other type of file to the ticket. The photo may be taken directly by the remote device 220, 225, or may be an existing photograph. At step 345, the user may save or cancel the ticket. Saving the ticket effectively creates the ticket.

In one embodiment, the user may select specific project-type templates to describe deficiencies more efficiently or more quickly at a particular type of project. As a non-limiting example, project-type templates may include healthcare, industrial/manufacturing, education, corporate office, sports venue, and the like. Each template may offer various types of category and subcategory options that can be selected by the user by means of an action pull down menu. As above, the user would also have the option to create custom modifications to the template at any time during the project. Any custom templates created for one project or for one deficiency list can also be exported for use in future projects. This embodiment assists in the bulk entry of customized fields, as the input screen offers the user a tree view of the input options and saves the user from having to re-enter data over and over again.

Further, the system 210 may give the user the ability to efficiently create multiple tickets in one location without reentering location-specific, room-specific, or deficiency-specific data again and again. This allows the requestor to reuse values during the ticket creation process (i.e., room, assignee, date, etc.) after creating a ticket, thereby creating greater efficiency in ticket creation. As noted above, after completing all of the required fields on a ticket, the user has the option to “create” the ticket. Then, once the ticket is created, the user has the ability to immediately create another ticket with several pieces of the data pre-populated based on the same data entered for the prior ticket. Upon creating the subsequent ticket, the user is presented with work flow options which determine field pre-population, if any. These pre-populated fields may include punch list, room identification, assignee, due date and description. After one ticket is created, the user is presented with specific options for the next step, including, for example: “Create Another,” “Create Duplicate,” etc. The “Create Another” option may pre-populate punch list selection, the room identification, and the completion due date for resolving the deficiency. The Create Duplicate option pre-populates the deficiency description or menu selection, the room identification, the party to whom the ticket is assigned, the completion due date for resolving the deficiency, and the free form text description field. This pre-population action through the Create Another and Create Duplicate options supplies all fields necessary to complete the ticket with the exception of the location marker and the photo.

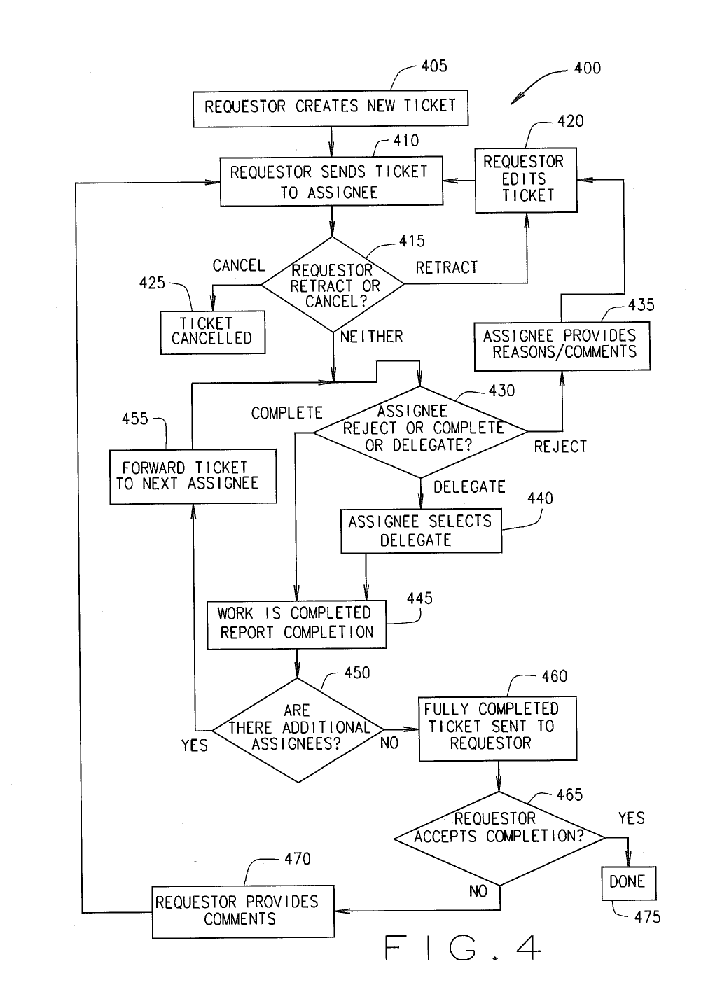

Once a ticket has been created, FIG. 4 illustrates an example process flow 400 for the ticket. At step 405, the Requestor creates the new ticket, as discussed above in connection with FIG. 3, and at step 410 the Requestor sends to the ticket to the selected Assignee. However, even after the ticket has been sent, the Requestor has the option at step 415 to retract or cancel the ticket. If the Requestor chooses to retract the ticket, at step 420, the Requestor essentially pulls the ticket back from the Assignee, and may modify the ticket as needed. The Requestor would then re-send the ticket to the Assignee at step 410 as discussed above, and the process 400 would proceed. Alternatively, at step 415, if the Requestor decides to cancel the ticket, at step 425 the ticket is cancelled and the process 400 is effectively done. However, if the Requestor neither retracts nor cancels the ticket at step 415, the process 400 moves forward.

At step 430, the ticket has been sent to the Assignee, and the Assignee may either reject, complete, or delegate the ticket. If the Assignee chooses to reject the ticket at step 430, the Assignee is asked to provide reasons/comments to the Requestor at step 435. The ticket is then sent back to the Requestor with the Assignee's comments, and the process 400 reverts to step 420 in which the Requestor may edit the ticket and resend it at step 410. Alternatively, at step 430, the Assignee may choose to delegate the ticket, in which case the Assignee selects a Delegate at step 440. Once the Delegate has completed the work, the completion is reported to the Requestor at step 445. However, rather than reject or delegate the ticket, at step 430 the Assignee may simply choose to complete the work. Once the work is completed, the completion is still reported to the Requestor at step 445.

At step 450, the system 210 detetrmines whether there are any additional Assignees listed on the ticket. Where there is at least one more Assignee listed on the ticket, the system 210 forwards the ticket to the next Assignee listed at step 455, at which point the process reverts back to step 430 in which the next Assignee can reject, complete, or delegate the work as discussed above. Alternatively, where there are no additional Assignees at step 450, the fully completed ticket is sent back to the Requestor for acceptance at step 460. The fully completed ticket may include photos or explanation from the Assignee to the Requestor regarding the completed task. At step 465, the Requestor may choose to accept the completed ticket, or not. If the Requestor is not satisfied with the work done by the Assignee(s), at step 470 the Requestor may provide comments as to such dissatisfaction, and re-send the ticket back to the Assignee at step 410. However, where the Requestor accepts the work at step 465, the process for this ticket is effectively completed at step 475. It is noted that the determinations as to whether there are additional assignees (step 450) and whether the Requestor accepts the completed ticket (step 465) could be reversed in order.

During the construction process, a user may choose to view certain tickets, according to the process 500 in FIG. 5. At step 510, a user chooses to view tickets. At step 520, the system 210 determines the user's permissions. For example, as discussed above an Assignee may be able to see all tickets, while a Delegate may only be able to see tickets to which they are assigned. At step 530, the system 210 allows the user to select various filters for the tickets. As non-limiting examples, the user may narrow by room/location, category, subcategory, date, assignee, recently viewed tickets, actions, etc. At step 540, the system 210 then filters the tickets and displays those tickets to the user which match the user's permissions and the filters selected by the user. This allows users to easily find and select tickets which need review and/or action.

An option made possible by the filtering discussed above, is the ability to perform basic review for duplicate tickets in order to eliminate unnecessary creation of additional tickets. If a user chooses to check for duplicate tickets, the System 210 preferably sorts all tickets that have the same location, category, and punch list. The user may then browse such tickets to determine whether any are duplicates. The user can also de-select punch list and re-check for duplicates from the new results list, and finally de-select category to view all tickets which have the same location. Again, after reviewing this list, the user should have found any duplicate tickets, and can cancel such duplicates. This process may run automatically when a user creates a ticket.

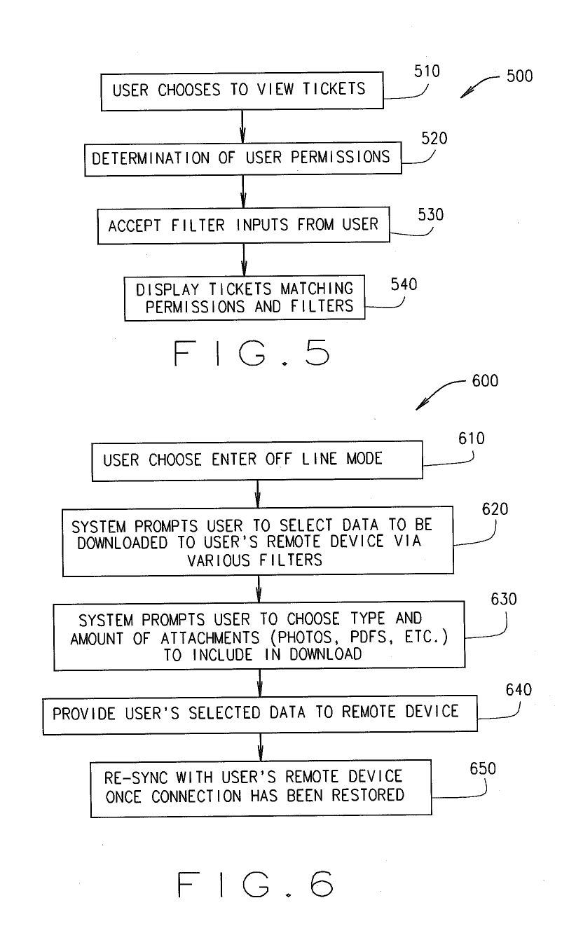

A further method 600 shown in FIG. 6 is the ability of users work in an off-line (non-internet-connected) mode. This functionality allows users to manipulate tickets on a mobile device even if not connected the SaaS or on a static device if not connected to the interne. As shown in FIG. 6, at step 610, a user chooses to work in off-line mode. At step 620, the System 210 prompts the user to select what data is to be downloaded to the user's remote device 215, 220, 225 prior to disconnection. For example, a user may choose to select all tickets relating to a specific room/location, or all tickets in a given punch list, or all tickets relating to a specific Assignee, etc. At step 630, the System 210 prompts the user to select the amount and type of attachments (e.g., photos, pdfs, CAD files, etc. which have been attached to the to-be-downloaded tickets) the user would like to download as well. This option allows users to control the amount of data to be downloaded. In practice, it has been determined that upwards of 98% of the total data stored in System 210 may be taken up by photos and such attachments. As many users have precious little storage on their smartphones/tablets 220, 225, and the options in Step 630 provide the user with the ability to control how much data is to be downloaded to the phone. If a user has chosen, for instance, to download an entire punch list, the user may choose to download the images and attachments of only a given Assignee or Requestor. At step 640, the System 210 provides the requested information to the user's remote device 215, 220, 225, which downloads it locally.

System 210 preferably syncs tickets and other information in the background while users are interacting with the System 210. However, especially in off-line mode, discussed above, some new tickets or changes to existing tickets may not be synced and uploaded to the System 210 immediately. In order to inform the user which tickets are synced with the rest of the System 210 and which have been modified, the System 210 preferably uses a color-coding scheme. For example, tickets which are synced with the System 210 may involve a grey color scheme or a grey banner. However, tickets which have not been synced (e.g, new tickets, change in a ticket's status, additions to a ticket, etc.) with the System 210 may involve a yellow color scheme or a yellow banner. Users may choose to force a system sync, or wait for the next sync to occur, for example at step 650 of FIG. 6 when the remote device 215, 220, 225 leaves off-line mode and re-connects with the System 210.

Many actions, such as creating a new ticket or rejecting a ticket or signaling completion of a ticket may also cause a notification email or other message to be sent to one or more users. However, in another embodiment of the present invention, the System 210 may allow users to batch and send multiple punch list tickets to responsible contractors at the same time, in order to avoid multiple notifications being generated. Users may also be able to send messages within the System 210 without rejecting, creating new, or otherwise editing tickets, so as to avoid additional notifications.

System 210 may also include the ability to create various summaries, lists and reports of the open/unfinished punch list items and closed/completed items and even unassigned items. These lists may be sorted or filtered in differing ways for review as well as for creating of summaries and reports regarding in-progress or complete items. Punch list reports may be organized by room, punch list item, trade contractor, requestor, date range, category, status, or by punch list. Reports can be produced in either PDF format, with or without thumbnails, or in a tabular data format (spreadsheet). Location-specific bar or QR codes used as a part of a facility content management system can be used to identify a user's punch list ticket location and access room-specific data quickly by auto populating a location or room field.

System 210 is preferably able to connect and integrate with enhanced or intelligent project drawings, including building information models (BIM), computer assisted drawings (AutoCAD), and the like to produce graphics in bulk if desired by the project owner. This integration allows for flexibility in the creation of new graphics due to project changes. These graphics may then be used to overlay the location markers. The location markers may therefore be stored in a separate layer from the underlying image layer. For example, as projects evolve, the underlying image layer onto which the pins are located may change. The underlying image from the construction documents may initially have no walls, while a later underlying image may include walls but no HVAC. As the project proceeds, different underlying images may be taken from the construction documents, but the pins remain in a separate overlaying layer and remain present even as the underlying layer changes.

A further method embodying the present invention is the ability to integrate static graphic sources including, but not limited to, PDFs in addition to editable CAD and BIM files. Regardless of the source or source file type, location graphics are combined with a tabular database file, like a .csv file, that defines the connection and functionality between location names and file names. The resulting data set can be put into a single, compressed zip file. The zip file may then be uploaded into the software to populate a project with the graphics, information, names, and similar data that allows for the core interactivity between the software and the project reflecting the way the project actually exists in reality.

System 210, via a mobile app or web-based browser application, via an API, may interact with a local or remote ERP system to automatically access information stored therein. For example, the ERP system could be accessed to quickly find information relating to sub-contractors—name, type of work, contact information, etc.

Another embodiment of the present invention is a system to manage an already constructed facility that assesses the condition of the constructed facility. Instead of a punch list of deficiencies, the list is of attributes needed to maintain the facility. The system functions in the same way as described above, but the terminology is fitted for a constructed facility instead of one that is under construction.

In addition, although generally described as being used in the construction industry and focusing on the end of the construction phase, an equivalent system can be used in a variety of industries including landscaping, construction of parking garages, road and highway construction projects and for use throughout the construction process and for post-construction applications.

The various system examples shown above illustrate a novel system and method. A user of the present invention may choose any of the above embodiments, or an equivalent thereof, depending upon the desired application. In this regard, it is recognized that various forms of the subject invention could be utilized without departing from the spirit and scope of the present invention.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A method for tracking a punch list, comprising the steps of:
(a) creating, via a processor, a ticket listing at least one deficiency based on inputs from a Requestor remote device;
(b) selecting, via a processor, at least a first Assignee for the deficiency based on inputs from the Requestor remote device;
(c) saving the ticket in an electronic memory;
(d) allowing said first Assignee to view the ticket via an Assignee remote device;
(e) allowing said first Assignee to report completion of work on the deficiency via the Assignee remote device; and
(f) closing the ticket upon Requestor acceptance of all completed work on the deficiency.

2. The method of claim 1 wherein a second Assignee is also selected for the deficiency.

3. The method of claim 2 further including the steps of:
(a) allowing the second Assignee to view the ticket via a second Assignee remote device after the first Assignee has reported completion of the first Assignee's work on the deficiency; and
(b) allowing the second Assignee to report completion of work on the deficiency via the second Assignee remote device.

4. The method of claim 1 further including the steps of:
(a) allowing the first Assignee to select a Delegate for work on the deficiency;
(b) allowing the Delegate to view the ticket via a Delegate remote device; and
(c) allowing the Delegate to report completion of work on the deficiency via the Delegate remote device.

5. The method of step 1, wherein upon viewing the ticket on the Assignee remote device:
(a) allowing the Assignee to reject the ticket and provide comments via the Assignee remote device;
(b) accepting revisions to the ticket from the Requestor via the Requestor remote device; and
(c) allowing the Assignee to view the revised ticket via the Assignee remote device.

6. The method of claim 1 wherein the ticket further includes information relating to the location of the deficiency.

7. The method of claim 1 wherein the ticket further includes a map of the location where the deficiency is located.

8. The method of claim 7 further including the step of:
(a) accepting a location of the deficiency on the map from the Requestor, via the Requestor remote device.

9. The method of claim 1 further including the step of:
(a) allowing the first Assignee to view all tickets associated with a punch list via the Assignee remote device.

10. The method of claim 9 further including the step of:
(a) allowing another user to view only a subset of all tickets associated with a punch list.

11. The method of claim 1 further including the steps of:
(a) filtering, via a processor, all tickets associated with a punch list according to criteria selected by a user via a remote device; and
(b) providing said filtered tickets to said user via the remote device.

12. The method of claim 11 wherein said criteria include at least one of location, Requestor, Assignee, category, subcategory, action, and surface.

13. The method of claim 11 further including the step of saving said criteria for later filtering.

14. The method of claim 1 further including the step of accepting an image from the Requestor of the deficiency for the ticket, via the Requestor remote device.

15. The method of claim 1 further including the step of filtering tickets for any tickets having the same location, category, and punch list so as to locate possible duplicate tickets.

16. The method of claim 1 further including the step of transmitting a notification to the Assignee regarding the creation of the ticket.

17. The method of claim 1 further including the step of allowing the Requestor to create a batch of tickets for the Assignee, and batch processing said batch of tickets to notify the Assignee only once.

18. The method of claim 1 further including the step of allowing the Requestor to revise the ticket via the remote device.

19. A method of administering a punch list, comprising the steps of:
(a) allowing a user to enter an off-line mode via a remote device;
(b) accepting at least one selection from the user via the remote device regarding tickets to be downloaded prior to switching to off-line mode;
(c) accepting at least one selection from a user via the remote device regarding desired data types of files associated with the tickets to be downloaded;
(d) providing tickets and data files associated with the provided tickets of the types chosen to said remote device; and
(e) re-syncing edits made to the provided tickets once the user exits off-line mode and reestablishes a connection with servers.

20. The method of claim 19 wherein the desired data types are image files, such that the user selects whether and the type of images files to download.

21. The method of claim 19 further including the steps of:
(a) allowing the user to edit the provided tickets during off-line mode; and
(b) color-coordinating any tickets which have been edited since the download thereof, as compared to tickets which have not been edited.

22. A system for managing a facility comprising:
a database for storing tickets associated with the facility in an electronic memory;
a processor for communicating with a Requestor remote device via a network, said processor for receiving inputs from the Requestor remote device regarding the creation of a new ticket listing at least one deficiency, said ticket listing an Assignee;
said electronic memory storing the new ticket therein, with associated criteria related to the deficiency;
said processor also for communicating with an Assignee remote device of the Assignee to provide said ticket to the Assignee remote device;
said processor receiving a report of completion of work on the deficiency via the Assignee remote device, and updating said ticket in said electronic memory to reflect completion; and
said processor closing the ticket in the electronic memory upon Requestor acceptance of all completed work on the deficiency.
